(19) United States
(12) Patent Application Publication
(10) Pub. No.: US 2011/0054872 A1
(43) Pub. Date: Mar. 3, 2011

(54) OPTICAL SIMULATOR USING PARALLEL COMPUTATIONS

(75) Inventors: Junqing Chen, San Jose, CA (US); Kartik Venkataraman, San Jose, CA (US)

(73) Assignee: Aptina Imaging Corporation, Grand Cayman, KY (US)

(21) Appl. No.: 12/550,657

(22) Filed: Aug. 31, 2009

(51) Int. Cl. G06G 7/62

(52) U.S. Cl. 703/13

(57) ABSTRACT

Systems and methods are provided for performing optical simulations using parallel computations. In some embodiments, the optical simulations can be performed on a computer system using raw image data provided by a camera. The computer system may include a central processing unit (CPU) and a graphics processing unit (GPU), where the GPU may be configured for the parallel computations. The CPU can build a lookup table of lens characterization data, such as point spread function (PSF) data. Using the lookup table, the GPU can perform the optical simulations. For example, the GPU can compute a plurality of convolutions in parallel, each using PSF data and a window of pixels. The result of each convolution may produce a pixel value that approximates the effect of the lens on that pixel.

### FIELD OF THE INVENTION

This can relate to systems and methods for performing optical simulations for a camera system.

### BACKGROUND OF THE DISCLOSURE

A computer system, such as those implemented in a portable electronic device or web cam, can include several components. For example, a typical camera system includes an optical lens, a sensor (e.g., CMOS or CCD sensor), and post-processing circuitry. Engineers designing a camera system typically want an accurate model of the camera system for use in performing simulations. This way, the effectiveness of the camera design can be verified prior to committing the design to silicon.

A camera simulator may use raw image data to model a real-world scene, and may simulate the effect of the camera on the raw image. Raw image data, however, can be very large. For example, high-end cameras can produce raw images that are 16 megabytes. Therefore, simulating a camera design may be difficult to accomplish within a reasonable and practical amount of time. Also, in some scenarios, running Monte Carlo tests may be desirable for tolerance checking on the camera system. These tests can result in even longer processing times due to the large amount of repeated computations needed to complete a Monte Carlo test.

### BRIEF DESCRIPTION OF THE DRAWINGS

FIG. 1 is a schematic view of an electronic device configured in accordance with various embodiments of the invention.

FIG. 2 is a flow diagram of a simulator for a camera system in accordance

with various embodiments of the invention.

FIG. 3 is a graphical representation of a lens projected onto a sensor to illustrate radially symmetric point spread function data in accordance with various embodiments of the invention.

FIG. 4 is an illustrative lookup table of radially symmetric point spread function data in accordance with various embodiments of the invention.

FIG. 5 is a flowchart of an illustrative process for performing an optical simulation pixel-by-pixel in accordance with various embodiments of the invention.

FIG. 6 is a flowchart of an illustrative process for performing an optical simulation using parallel computations in accordance with various embodiments of the invention.

FIG. 7 is a graphical representation of a lens projected onto a sensor to illustrate asymmetric point spread function data in accordance with various embodiments of the invention.

### DETAILED DESCRIPTION OF THE DISCLOSURE

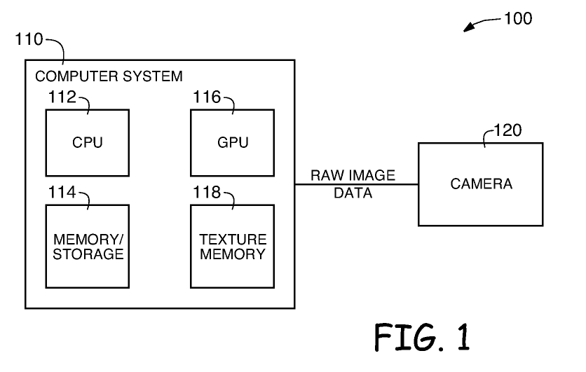

FIG. 1 is a schematic view of an illustrative system 100 for simulating camera systems. System 100 can include computer system 110 for running the simulations and camera 120 that can provide raw image data to computer system 110 for the simulations. Computer system 110 can include a personal computer, laptop computer, or any other suitable type of computing platform capable of running simulation software. Camera 120 may include any suitable type of camera that can capture scene data, such as a high resolution digital camera, at multiple different exposures.

Computer system 110 can include central processing unit (“CPU”) 112, memory/storage unit 114, graphics processing unit (“GPU”) 116, and texture memory 118. CPU 112 can control the general operations of computer system 110 using one or more processors acting under the control of software/firmware stored in memory/storage unit 114. The one or more processors may have any of the features and functionality of any CPUs currently in use or developed in the future. CPU 112 can perform some or all of the functions to complete the simulations of a camera system.

Memory/storage unit 114 can include any combination of volatile and non-volatile memories, such as SDRAM, DDR RAM, flash memory, magnetic drives, and/or ROMs. Memory/storage unit 114 can operate as the main memory for CPU 112, can store the firmware/software used by CPU 112, and may provide mass storage for computer system 110. For example, memory/storage unit 114 may be used to store the raw image data provided from camera 120, any parameters or data used to initiate the simulations (e.g., lens characterization data, lookup tables), and any intermediate or results data generated from the simulations.

GPU 116 can include any suitable graphics processing unit that is designed for rendering graphics. For example, GPU 116 can be implemented on a card and used to generate high-definition 3D graphics for presentation on a 2D display. GPU 116 can include an application programming interface (API) that allows a programmer to utilize both CPU 112 and GPU 116 for processing data. In this way, some of the functions to complete the camera system simulations can be completed by GPU 116. GPU 116 can operate using data from texture memory 118. Texture memory 118 can include any suitable type of memory or storage unit, such as any combination of those discussed above in connection with memory/storage unit 114.

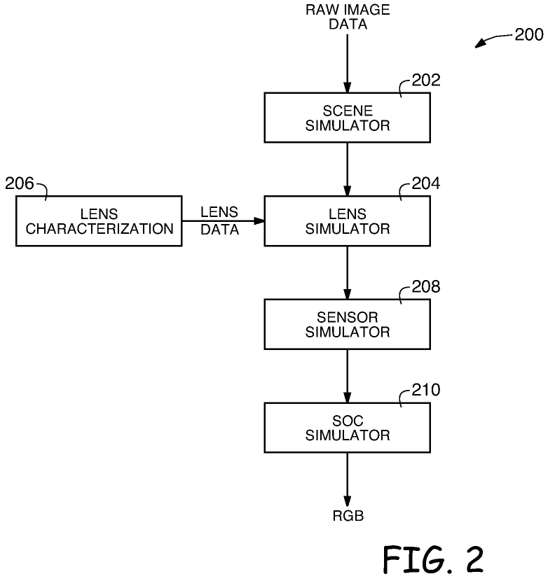

FIG. 2 shows a flow diagram of a simulation 200 of a camera system that can be performed by CPU 112 and/or GPU 116. For example, each step in simulation 200 can include one or more software modules that are each executed by CPU 112 and/or GPU 116 to complete a full simulation of a camera system. The camera system that is simulated can be of any type, such as a camera system included in an embedded system (e.g., cellular telephone, web cam, portable media player, or gaming device).

Simulation 200 can include scene simulator 202, lens simulator 204, sensor simulator 208, and system-on-a-chip (“SOC”) simulator 210. Scene simulator 202 can direct CPU 112 and/or GPU 116 to convert raw image data, such as raw image data obtained from camera 120 of FIG. 1, into hi-dynamic range (“HDR”) 2D or 3D multi-spectral representations or non-HDR 2D or 3D multi-spectral representations. Scene simulator 202 may therefore produce high-resolution images that represent a real-world scene. Using lens simulator 204, CPU 112 and/or GPU 116 can simulate the effect of a lens on the multi-spectral representation of the scene. The simulated lens may be used to focus light on a camera system's sensor, and CPU 112 and/or GPU 116 may simulate any optical distortions and other aberrations due to the lens. For example, lens simulator 204 can take into account blurring produced by a lens, which may be characterized for each pixel of the sensor by a “point spread function” or “PSF.” The point spread function may represent the impulse response at a point relative to the lens. Lens simulator 204 can model a camera lens as a linear system and may direct CPU 112 and/or GPU 116 to perform convolutions of the multi-spectral representation with the PSF for each pixel and each wavelength.

The PSFs for the lens, as well as other data characterizing the effect of the lens (e.g., focal length, F number, maximum field height, etc.), can be obtained from lens characterization module 206. Lens characterization module 206 can include any suitable software or macro that provides lens characterization data for a particular lens design. For example, lens characterization module 206 can include any tool that allows CPU 112 and/or GPU 116 to sample and extract lens characterization data at various wavelengths and locations relative to the lens without releasing the lens design.

The results of lens simulator 204 may be passed to sensor simulator 208. Sensor simulator 208 can model the effects of a camera system's sensor, such as a CMOS or CCD sensor. These effects can include, for example, crosstalk and noise. Using sensor simulator 208, CPU 112 and/or GPU 116 can produce a raw Bayer image by collecting the electrons through all wavebands, areas, and exposure times, and accounting for the noise and other effects. Then, to produce the final simulated RGB output, SOC simulator 210 can simulate the additional effects of an embedded system, such as any color balancing or other image correction features applied to the image.

One of the bottlenecks of the simulation process illustrated in FIG. 2 is the PSF convolution in lens simulator 204 for each pixel. The bottleneck is due in part to the PSF varying for each pixel location on a sensor relative to the lens and for each wavelength. Thus, embodiments described in this disclosure provide various techniques for performing optical simulations using a CPU and/or GPU in a manner that can reduce the bottleneck. The various embodiments will be described for increasing the speed of PSF convolutions. It should be understood, however, that the described techniques may be applied to other applications in which multiple computations of the same type or function are performed (e.g., convolutions or other filtering functions), but where the initial parameters may vary (e.g., the characteristics of the filter).

In some embodiments, computer system 110 can build a lookup table for use in lens simulator 204. The lookup table can include PSF data for multiple pixel locations of a sensor and can be stored in, for example, memory/storage unit 114. For pixel locations not included in the lookup table, computer system 110 can compute the PSF data for that pixel location by interpolating the PSF data from neighboring pixel locations. Interpolation may produce suitably accurate PSF values, because the PSF typically changes slowly from one location of a lens to another.

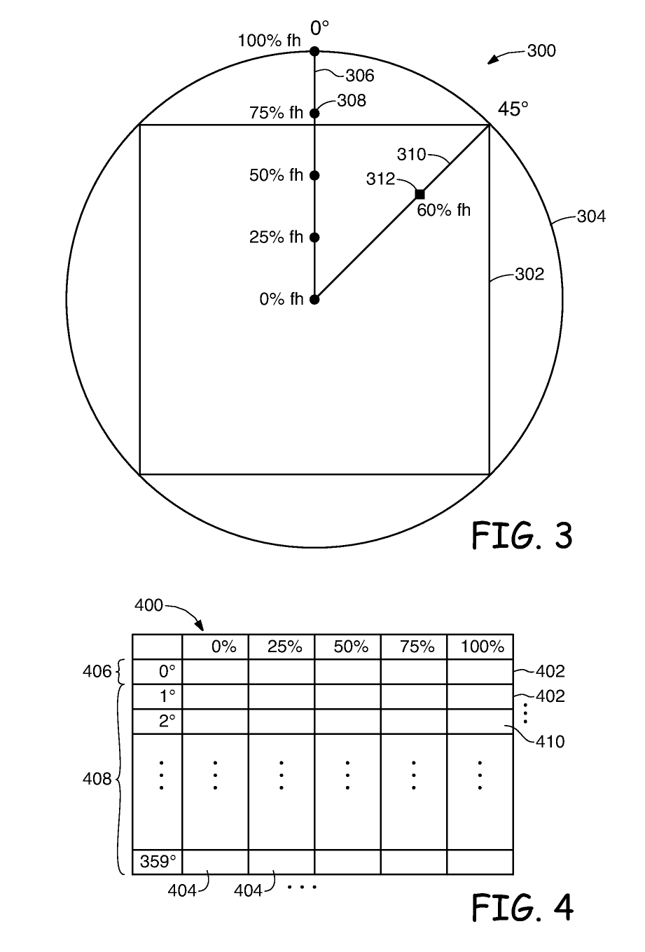

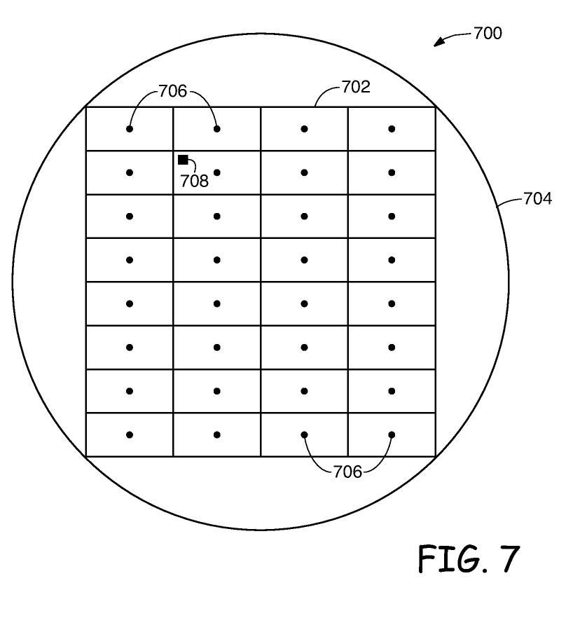

FIG. 3 illustrates one way in which computer system 110 can generate and use a lookup table of PSF data. In particular, FIG. 3 is a graphical representation 300 of a lens 304 projected onto a sensor 302, where sensor 302 can include a number of pixels. In this figure, as well as in FIG. 7, sensor 302 is depicted as having its corners and center aligned with the perimeter and center of lens 304, respectively. It should be understood that computer system 110 can make any adjustments to the computations described below to model scenarios where such alignment is not present.

The location of each pixel in sensor 302 relative to lens 304 can be defined by an angle and a field height. The “angle” may be relative to any arbitrary line 306, which can represent a zero degree line. The “field height” or “fh” may refer to the distance of the pixel location from the center of lens 304, and may generally be referred to by a percentage of the maximum field height. For example, FIG. 3 illustrates multiple field heights located along zero degree line 306, where the 0% location may be at the center of lens 304 and the 100% location may be at the edge of lens 304.

The point spread function associated with each pixel on sensor 302 may depend on the wavelength, angle, field height, and any other relevant parameters. In some embodiments, computer system 110 can simulate lens 304 using a PSF model that is independent of angle, which may also be referred to as a “radially symmetric” model. That is, computer system 110 can operate under an assumption that the point spread function for two pixels having the same field height, but different angles, may be rotated versions of one another. Using this assumption, computer system 110 may need the PSF data for pixels located along one line (e.g., line 306) and may calculate the PSF data for other locations using rotation operations. The rotation operations may be based on affine transforms performed by CPU 112, for example.

For example, computer system 110 can obtain the PSF for multiple locations, including location 308, along line 306. These PSFs may be obtained by directing lens characterization module 206 of FIG. 2 to sample along line 306, for example. While FIG. 3 illustrates five locations, computer system 110 can obtain the PSF for any suitable number of locations (e.g., 10, 12, 21, etc.). Computer system 110 may then compute rotated versions of these PSFs for any suitable number of different angles. In some embodiments, computer system 110 can compute a set of PSF rotations at each integer angle (e.g., 0°, 1°, . . . , 359°), but any other suitable set of angles may be used instead. The PSFs obtained from lens characterization module 206 and those computed thereafter may be stored in a lookup table, such as lookup table 400 of FIG. 4.

FIG. 4 illustrates a lookup table 400 that can be built by computer system 110 using a radially symmetric PSF model. One or more of lookup table 400 may be stored in memory/storage unit 114, where each stored lookup table 400 may be associated with a particular wavelength.

Lookup table 400 can include an array of cells, including cell 410. Each of the cells may contain PSF data for a particular location on sensor 302 relative to lens 304. Lookup table 400 may be arranged into multiple rows 402 for storing PSF data at different angles, and may also include multiple columns 404 for storing PSF data of different field heights. Row 406, corresponding to 0° line 306 of FIG. 3, can include PSF data obtained from lens characterization module 206 of FIG. 2. The lens characterization data in rows 408 can be computed by computer system 110 based on the PSF data stored in row 406.

It should be understand that the number of rows 402 and columns 404 is merely illustrative. Lookup table 400 may be of any suitable size. For example, in some embodiments, lookup table 400 may have PSF data for 21 field heights at each angle (e.g., for field heights of 0%, 4.8%, . . . , 100% of the maximum field height) instead of the illustrated five field heights.

Computer system 110 can use lookup table 400 to approximate the PSF for any location on sensor 302. For example, computer system 110 can compute the PSF for pixel location 312 even though the position corresponding to a 45° angle and 60% field height may not be present in lookup table 400. Computer system 110 can read PSF values for neighboring locations based on the neighboring location's angle and field height, and may compute an approximate PSF by interpolation along an angle and/or field height. For example, for pixel location 312, computer system 110 can interpolate along the 45 degree angle line using one or more of the PSF values for that angle (e.g., using any of the PSF values for the row in lookup table 400 corresponding to 45 degrees). As another example, for a pixel location at 60% field height and a non-integer angle, computer system 110 can interpolate using one or more nearby positions having PSF data in the lookup table.

While some of the PSF data may be referred to as being “approximate,” this term is used merely for simplicity, and is not intended to suggest that the PSF data is more or less accurate than other PSF data. In general, “approximate” PSF data may sometimes refer to PSF data that is not obtained from a lens characterization module, such as lens characterization module 206. Therefore, the PSF data stored in rows 408 of lookup table 400 may sometimes be referred to as approximate, as well as any of the PSF data generated based on interpolation and resampling.

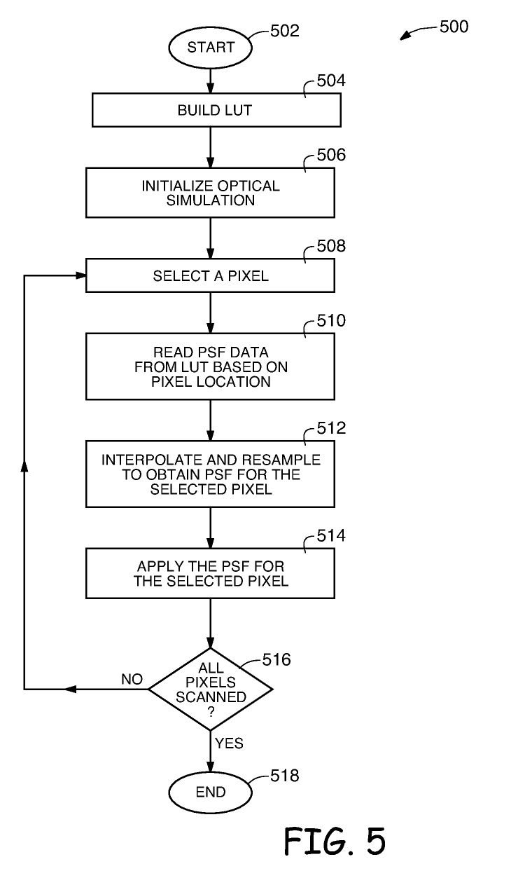

Referring now to FIG. 5, a flowchart of an illustrative process 500 is shown for performing an optical simulation for a particular wavelength. The steps of process 500 may be performed by a computer system 110 while executing lens simulator 204. Process 500 illustrates an optical simulation that is computed pixel-by-pixel. In some embodiments, process 500 may be executed by CPU 112 due to the serial nature of the computations. Although the steps of process 500 are described as being executed by CPU 112, it should be understand that any suitable hardware-based or software-based control module for any suitable type of desktop or handheld device or system may execute these steps instead.

Process 500 may begin at step 502. At step 504, one or more lookup tables may be built. For example, CPU 112 can create lookup tables similar to lookup table 400 of FIG. 4. Then, at step 506, CPU 112 can initialize various tools and parameters needed for the optical simulation. For example, CPU 112 can perform padding, compute the angle and field height of each pixel, and create a buffer on memory/storage unit 114 for holding the results of the PSF convolutions.

Following step 506, CPU 112 can execute multiple iterations of steps 508 through 516 to compute the PSF convolution for the pixels. Starting with step 508, CPU 112 can select a pixel for computing a PSF convolution. Then, at step 510, PSF data may be read from the lookup table based on the location of that pixel on the sensor. CPU 112 can read, for example, PSF data for two or more neighboring locations (e.g., two or more locations proximate to the pixel location). Using the PSF data read from the lookup table, CPU 112 can compute an approximate PSF for the currently selected pixel at step 512. For example, CPU 112 can interpolate the PSF data obtained in step 510 and resample the interpolated PSF data to match the sampling rate of the optical image.

At step 514, CPU 112 can apply the computed PSF for the current pixel. To apply the PSF, a convolution of the PSF with a number of pixels (including the selected pixel) may be performed. That is, CPU 112 can perform the convolution on the PSF with a window of pixels centered on the selected pixel. The PSF convolution may produce the simulation result for the selected pixel.

Continuing to step 516, CPU 112 can determine whether all of the pixels of the sensor have been scanned. If, at step 516, CPU 112 determines that the PSF convolution has been performed for all of the pixel locations, process 500 can move to step 518 and end. Otherwise, process 500 moves back to step 508, where CPU 112 can select another pixel to simulate. This way, process 500 may iterate through some or all of the pixel locations on a sensor to determine at least some of the effects that a lens may have on each pixel location.

As illustrated in FIG. 5, CPU 112 can build a lookup table at step 504 prior to starting the iterations of steps 508 through 516. This prevents CPU 112 from having to perform rotation operations as part of the iterations, which may account for a large proportion of the time used during an optical simulation. Therefore, building the lookup table in advance of these iterations may provide a substantial increase in simulation speed. The interpolation and resampling operations of step 510, unlike the rotation operations used to generate the lookup table, may be considerably less resource-intensive, allowing for the substantial increase in speed.

The steps of process 500 illustrate a technique for completing an optical simulation pixel-by-pixel. A pixel-by-pixel simulation scheme may be time consuming and impractical even with the use of a lookup table, because there may be many pixels in an image. Accordingly, in some embodiments, computer system 110 can compute the PSF convolutions for multiple pixels in parallel. That is, computer system 110 can start multiple PSF convolutions at the same time or around the same time such that at least some of the convolution calculations overlap. This way, the time required to perform the simulation can be substantially reduced (e.g., to 1-3 hours for a 16M image).

Computer system 110 can use any of a variety of techniques for performing parallel computations, such as using multiple CPUs (e.g., multiple CPUs 112) or spreading the computations to multiple computer systems (e.g., using multiple computer systems 110). In other embodiments, computer system 110 can use graphics processing unit 116 to compute at least some of the PSF convolutions in parallel. In these embodiments, data may be passed between CPU 112 and GPU 116 to complete the optical simulation. This way, operations that are more efficient or effective for execution by a central processing unit can be performed by CPU 112, and vice versa.

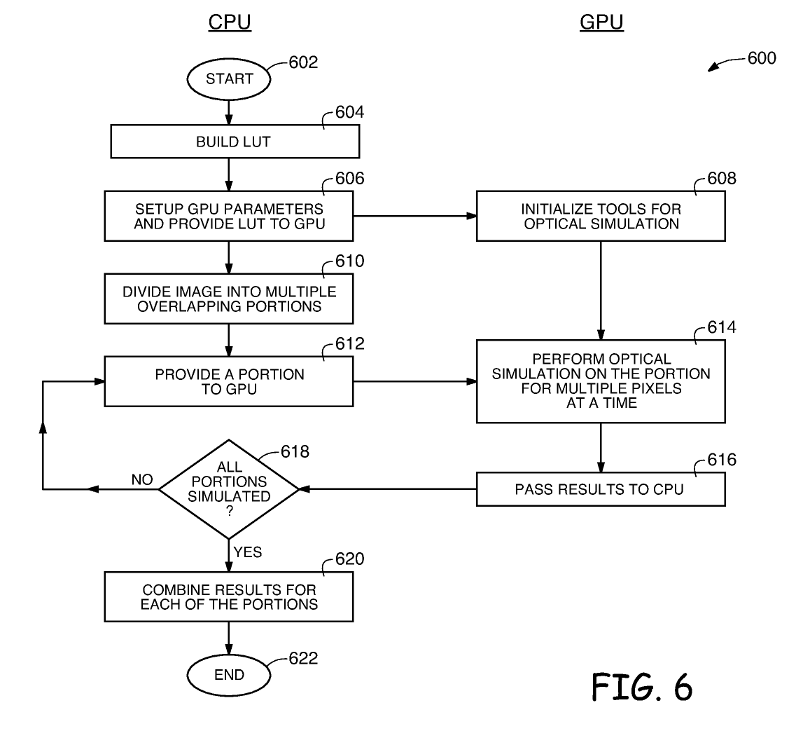

FIG. 6 is a flowchart of an illustrative process 600 is shown for performing an optical simulation for a particular wavelength that includes parallel computations. The steps of process 600 may be performed by a computer system 110 while executing lens simulator 204 of FIG. 2. For example, CPU 112 and GPU 116 of computer system 110 may be configured to execute the steps on the left-hand and right-hand side of FIG. 6, respectively. Although the steps of process 600 are described as being executed by CPU 112 and GPU 116, it should be understand that any suitable hardware-based or software-based control module for any suitable type of desktop or handheld device or system may execute these steps instead.

Process 600 may begin at step 602. At step 604, CPU 112 may build one or more lookup tables containing PSF data. The lookup tables may be similar or have any of the features of lookup table 400 of FIG. 4. Then, at step 606, CPU 112 may set up parameters that configure the operation of GPU 116. These GPU parameters may set the precision of computations and may determine which features of GPU 116 should be used in the PSF convolutions. For example, CPU 112 may set up GPU 116 by turning off features of GPU 116 that are used primarily for rendering 3D graphics prior to display. GPU 116 can use the GPU parameters to initialize tools for the optical simulation at step 608.

Returning to step 606, CPU 112 can provide the lookup table built at step 604 and any other suitable information about the simulated lens to GPU 116.

In some embodiments, CPU 112 may store the lookup table and other lens characterization data in texture memory 118 for use by GPU 116. Texture memory 118 may have dimensions different from memory/storage unit 114, which is where the lookup table may originally be stored. Step 606 may therefore involve converting or reorganizing the lookup table so that the resulting lookup table has dimensions suitable for texture memory 118.

Continuing to step 610, CPU 112 can divide the image into multiple portions, which each may be fed into GPU 116 separately at step 612. Processing the image portion-by-portion may be beneficial for a variety of reasons, such as for reducing the time it takes for GPU 116 to return data to CPU 112. This can ensure that CPU 112 does not time out while waiting for simulation results from GPU 116. Because the PSF convolution for each pixel uses values for multiple surrounding pixels, the image portions created and fed into GPU 116 may be overlapping. This may ensure that sufficient pixels are included in the portions for PSF convolutions to be performed for pixels near the edge of the portions. CPU 112 can divide the image into any suitable number of portions, such as 2, 4, 10, or 16 portions.

Along with each portion, CPU 112 can provide positional information for the current portion to GPU 116 at step 612. The information can indicate the position of the current portion relative to the full image, and may include the x-y coordinates of a corner pixel, for example. This way, GPU 116 can determine which locations of the lookup table to read from when performing optical simulations at step 614.

At step 614, GPU 116 can perform an optical simulation on the current portion of the image for multiple pixels at a time. Step 614 can involve any of the operations discussed above in connection with iteration steps 508 through 514, except that the operations may be performed for multiple pixels substantially concurrently. For example, GPU 116 can read PSF data from the lookup table created by CPU 112, can interpolate and resample the PSF data to obtain an approximate PSF for a current pixel, and can perform PSF convolutions to generate pixel values that simulate the effects of a lens.

In some embodiments, the convolutions performed at step 614 can involve GPU 116 computing the PSF convolutions for pixels based on EQ. 1, where N rows×M columns of pixels are used in the convolution for each pixel and the size of each PSF is M rows×N columns:

$${I}_{out} ( x , y ) = {\sum }_{j = 0}^{M - 1} {\sum }_{i = 0}^{N - 1} I ( x - \frac{N - 1}{2} + i , y - \frac{M - 1}{2} + j ) \cdot {F}_{x - \frac{N - 1}{2} + i , y - \frac{M - 1}{2} + j} ( N - 1 - i , M - 1 - j ) \qquad ( EQ . 1 )$$

In EQ. 1, Iₒᵤₜ(x, y) is the result of the convolution for a pixel at coordinates (x,y), where (x,y) may be the coordinates for a pixel centered in the N×M window of pixels. I may include the initial values of the image data to be convolved with. F_{x,y} may represent the value of the PSF at (x,y), which may be calculated using any of the above-described techniques. The coordinate system may be defined such that the top left corner of the image portion or PSF kernel is at (0,0), and the y axis points down. Also, the variables N and M can take on any suitable odd value, and may be based on the characterization of the lens (e.g., from lens characterization module 206 of FIG. 2.

At the completion of the PSF convolution and/or any other simulation computations, GPU 116 can pass the results back to CPU 112 at step 616. For example, GPU 116 can provide the convolution results for the current portion of the image from texture memory 118. This way, CPU 112 can determine that GPU 116 has completed processing of the current portion of the image. Then, at step 618, CPU 112 can determine whether all of the portions of the image have been processed by GPU 116. If not, process 600 can return to step 612, and CPU 112 can provide another portion of the image to GPU 116 for processing.

If, at step 618, CPU 112 determines instead that the PSF convolutions have been completed for all portions of the image, process 600 can continue to step 620. At step 620, CPU 112 can combine the convolution results for all of the image portions. For example, CPU 112 can stitch the resulting pixels or pieces of the image back together to re-form a complete image, where the complete image reflects the effects of a lens on a sensor. To do this, CPU 112 can maintain positional information about each of the portions so that CPU 112 can stitch the pixels together in the original order. Then, process 600 can move to step 622 and end.

It should be understood that processes 500 and 600 of FIGS. 5 and 6, respectively, are merely illustrative. Any of the steps may be removed, modified, or combined, and any other steps may be added, without departing from the scope of the invention. For example, process 600 can include further steps for performing sensor simulations (e.g., as part of sensor simulator 208 of FIG. 2) using GPU 116 in additional to the optical simulations at step 614. The sensor simulations can include computing the optical-to-sensor plane mapping, such as performing resampling operations. As another example, LUT-building step 602 and simulation step 614 may be modified based on any the features, functionalities, and embodiments described below.

In some embodiments, GPU 116 may be configured to perform rotation operations instead of having CPU 112 build a lookup table that includes PSF data for multiple angles. These rotation operations may be performed as part of simulation step 614 of FIG. 6, for example. Compared to the rotations performed by CPU 112, the GPU 116 may use a different, simplified, and/or less precise rotation operation to prevent the rotation operation from consuming the resources of GPU 116. For example, the rotation operation may be based on a simple geometrical rotation followed by a bilinear interpolation.

With GPU 116 performing the rotation operations, GPU 116 can use a lookup table that includes only PSF data for pixels at one angle. For example, at steps 604 and 606 of FIG. 6, CPU 112 can build and provide GPU 116 with a lookup table including only row 406 of lookup table 400 (FIG. 4). Accordingly, the size of the lookup table may be reduced by a substantial amount, and the memory requirements of texture memory 118 may be relaxed.

In some embodiments, computer system 110 may perform simulations for scenes that are three-dimensional. That is, the scenes may include image data for not only different (x,y) coordinates, but also at different depths for each (x,y). Simulations for 3D images may be both possible and practical in embodiments where GPU 116 performs the rotations, because the extra dimension does not necessarily require an increase in the size of the lookup table. That is, instead of using CPU 112 to create a larger 3D lookup table, GPU 116 can alter the way in which the rotations are performed using the same 2D lookup table. The altered rotations may be based on an angle and a depth. For example, GPU 116 can use a depth-dependent interpolation to compute the rotations.

Various embodiments have thus far been described as being configured to perform optical simulations using a radially symmetric PSF model. It should be understood that this is merely illustrative, and that other PSF models may be used instead. For other PSF models, the lookup table and other computations may be different from those described above, and can instead apply different assumptions made by the other PSF models.

In some embodiments, computer system 110 may be configured to perform optical simulations using an asymmetric PSF model. In these embodiments, computer system 110 may operate under the assumption that the PSF varies based on both the angle and field height, and not just on the field height. Asymmetric PSF models may be used to simulate scenarios where, for example, the lens is tilted with respect to the sensor by some degree.

FIG. 7 illustrates one way in which computer system 110 can generate and use a lookup table of PSF data using an asymmetric PSF model. In particular, FIG. 7 is a graphical representation 700 of a lens 704 projected onto a sensor 702. Because of the asymmetric assumption, computer system 110 can direct lens characterization module 206 (FIG. 2) to sample the PSF in a grid instead of along a line. This way, computer system 110 can obtain this lens characterization data for locations 706, where locations 706 may each correspond to a center of a cell in a regular grid having any suitable number of rows and columns.

Computer system 110 (e.g., via CPU 112) may build a lookup table from the PSF data sampled for locations 706. The lookup table may be organized based on the x-y coordinates of sampled locations 706, for example, and may be passed to GPU 116. GPU 116 can compute the PSF for any given pixel in sensor 702 by performing an interpolation using four nearest neighbors (e.g., four sampled locations proximate to the given pixel). For example, to compute the PSF for pixel 708, GPU 116 can perform a bilinear interpolation with the four sampled locations in the top-left corner of sensor 702. The parallel nature and structure of GPU 116 may enable GPU 116 to determine the nearest neighbors and perform the interpolation without consuming an impractical amount of time or other system resources.

In some embodiments, GPU 116 can use more or less than four neighboring sample locations to approximate the PSF for any given pixel (e.g., two, three, six, or eight neighbors). In still other embodiments, CPU 112 may be configured to build the lookup table and complete the PSF convolutions. In these embodiments, CPU 112 may perform the interpolations of four nearest neighbors instead of GPU 116.

In conclusion, systems and methods are provided for performing optical simulations using parallel computations. In some embodiments, the optical simulations can be performed on a computer system using raw image data provided by a camera. The computer system may include a central processing unit (CPU) and a graphics processing unit (GPU), where the GPU may be configured for parallel computations. The raw image data may be used to model a high-resolution, real-world scene.

In some embodiments, the CPU may be configured to build a lookup table that includes lens characterization data. The lens characterization data may be associated with a plurality of locations (e.g., pixel locations) on a sensor relative to a lens, and can include, for example, data for point spread functions (PSFs). The GPU may use the lookup table to approximate the optical effects of the lens (e.g., blurring, distortions, etc.) on pixels of the sensor. The optical simulation may include a plurality of parallel computations, such as a plurality of PSF convolutions, where each PSF convolution provides a pixel value for a different pixel.

In some embodiments, the CPU can build the lookup table by obtaining a first portion of the lens characterization data from a lens characterization module, such as a software module designed to provide detailed characteristics for particular lens designs. The CPU can approximate a second portion of the lens characterization data using the first portion. For example, using a radially symmetric model, the CPU can rotate the lens characterization data to obtain the second portion. In other embodiments, the lookup table may include only the first portion of the lens characterization data, and the rotation operations may be performed by GPU during the optical simulation.

In other embodiments, the CPU can build the lookup table using an asymmetric model of PSFs, for example. In these embodiments, the CPU may build the lookup table using lens characterization data sampled from locations relative to the lens in a pattern corresponding to a regular grid. To obtain lens characterization data for other locations during the optical simulation, the GPU can perform an interpolation using four nearest neighbors—that is, using four sampled locations proximate to a current pixel location.

In some embodiments, a method is provided for simulating an effect of a lens on a sensor. The method can include obtaining PSF data for a plurality of locations of the sensor relative to the lens and generating approximate PSF data for at least some of the pixels based on obtained data. Then, a plurality of convolutions may be computed using the approximate data and windows of the pixels, where at least two of the convolutions may be performed in parallel. Each of the convolutions may be associated with one of the pixels. For example, each convolution may produce a pixel value for one of the pixels that is affected by the simulated lens.

In still other embodiments, a method is provided for performing an optical simulation on an image using a computer system. The computer system can include a CPU and a GPU. In the method, an image may be divided into a plurality of overlapping portions using the CPU. For example, the image may be divided in 16 overlapping portions. At least one of the overlapping portions may be provided from the CPU to the GPU. For example, the CPU may provide the overlapping portions to the GPU one at a time for processing. The CPU may also provide the GPU with lens characterization data, such as PSF data or a lookup table of PSF data, associated with a particular lens design.

The method can then involve the GPU performing an optical simulation on the particular lens design based on the lens characterization data and the at least one overlapping portion. For example, the GPU can perform rotation and/or interpolation and resampling operation. For 3D scenes, the GPU can perform depth-dependent rotation or operations on the lens characterization data. The GPU may also perform PSF convolutions in the optical simulation. The results of the optical simulation for each of the overlapping portions may be combined by the CPU. For example, the CPU may re-form a complete image from the groups of pixels generated from the optical simulations.

The described embodiments of the invention are presented for the purpose of illustration and not of limitation, and the invention is only limited by the claims which follow.

What is claimed is:

1. A computer system comprising:
a central processing unit configured to build a lookup table comprising lens characterization data, wherein the lens characterization data is associated with a plurality of locations on a sensor relative to a lens; and
a graphics processing unit configured to run an optical simulation using the lookup table to approximate optical effects of the lens on pixels of the sensor, wherein the optical simulation comprises a plurality of parallel computations, each of the computations associated with a different one of the pixels.

2. The computer system of claim 1, wherein:
the lens characterization data comprises point spread function (PSF) data for the plurality of locations; and
the plurality of computations comprises a plurality of convolutions using the PSF data.

3. The computer system of claim 1, wherein the central processing unit is configured to build the lookup table by:
obtaining a first portion of the lens characterization data from a lens characterization module; and
approximating a second portion of the lens characterization data using the first portion.

4. The computer system of claim 1, wherein the graphics processing unit is configured to run the optical simulation by:
for at least one of the pixels, reading from the lookup table lens characterization data for locations proximate to the at least one pixel; and
interpolating the lens characterization data for the proximate locations to obtain lens characterization data for the at least one pixel.

5. The computer system of claim 1, wherein the optical simulation is performed on an image, and wherein the central processing unit is further configure to:
divide the image into a plurality of overlapping portions; and
direct the graphics processing unit to run the optical simulation on one of the overlapping portions at a time.

6. The computer system of claim 1 further comprising a texture memory, wherein the central processing unit stores the lookup table in the texture memory for use by the graphics processing unit.

7. A method of simulating an effect of a lens on a sensor, the sensor comprising a plurality of pixels, the method comprising:
obtaining point spread function (PSF) data for a plurality of locations of the sensor relative to the lens;
generating approximate PSF data for at least some of the pixels based on the obtained PSF data; and
computing a plurality of convolutions using the approximate PSF data, each of the convolutions producing a pixel value for one of the pixels, wherein at least two of the convolutions are performed in parallel.

8. The method of claim 7, wherein:
each of the locations relative to the lens is associated with an angle and a field height,
obtaining the PSF data comprises obtaining a first portion of the PSF data for locations of the lens having the same angle and different field heights; and
the method further comprises performing rotation operations on the first portion of the PSF data to generate a second portion of the PSF data for locations of the lens along remaining angles.

9. The method of claim 7, wherein obtaining the PSF data comprises sampling locations relative to the lens in a pattern corresponding to a regular grid.

10. The method of claim 9, wherein generating the approximate PSF data for a particular pixel comprises performing an interpolation using a plurality of the sampled locations proximate to the particular pixel.

11. The method of claim 10, wherein the interpolation uses exactly four sampled locations proximate to the particular pixel.

12. The method of claim 7, wherein at least one of the convolutions is performed using a window of pixels, the window include the pixel associated with the at least one of the convolutions.

13. A method of performing an optical simulation on an image using a computer system having a central processing unit (CPU) and a graphics processing unit (GPU), the method comprising:
dividing the image into a plurality of overlapping portions using the CPU;
providing, from the CPU to the GPU, at least one of the overlapping portions and lens characterization data associated with a particular lens design;
performing, on the GPU, an optical simulation of the particular lens design based on the lens characterization data and the at least one overlapping portion; and
combining results of the optical simulation for different overlapping portions using the CPU.

14. The method of claim 13, wherein the optical simulation comprises a plurality of convolution operations, wherein at least two of the convolution operations are performed in parallel.

15. The method of claim 13, further comprising configuring parameters of the GPU using the CPU, wherein the configuring enables the GPU to perform the computations of the optical simulation.

16. The method of claim 13, further comprising:
building a lookup table using the CPU, the lookup table comprising the lens characterization data for a plurality of locations relative to the lens, wherein providing the lens characterization from the CPU to the GPU comprises providing the lookup table to a texture memory.

17. The method of claim 13, wherein providing the at least one of the overlapping portions comprises:
providing a first portion of the image for processing by the GPU;
determining that the GPU has completed the processing of the first portion; and
providing a second portion of the image for processing by the GPU.

18. The method of claim 13, wherein the image is a three-dimensional scene defined by x-y orthogonal coordinates and a depth, and wherein performing the optical simulation comprises performing depth-dependent rotation or interpolation operations on the lens characterization data.

19. The method of claim 13, wherein performing the optical simulation comprises interpolating the lens characterization data obtained from the CPU to generate approximate lens characterization data for a particular pixel.

20. The method of claim 13, wherein the results of the optical simulation comprise pixel values, and wherein combining the results comprises re-forming a complete image using the pixel values associated with each of the portions.
